(19) United States
(12) Patent Application Publication
(10) Pub. No.: US 2015/0214610 A1
(43) Pub. Date: Jul. 30, 2015

(54) SOLID-STATE PLASMA ANTENNA

(71) Applicant: ELECTRONICS & TELECOMMUNICATIONS RESEARCH INSTITUTE, Daejeon (KR)

(72) Inventors: Cheol Ho KIM, Gunpo-si (KR); Gweon Do JO, Daejeon (KR); Kwang Chun LEE, Daejeon (KR)

(73) Assignee: ELECTRONICS & TELECOMMUNICATIONS RESEARCH INSTITUTE, Daejeon (KR)

(21) Appl. No.: 14/604,302

(22) Filed: Jan. 23, 2015

(30) Foreign Application Priority Data
Jan. 24, 2014 (KR) 10-2014-0008764

(51) Int. Cl. H01Q 1/36

(52) U.S. Cl. CPC H01Q 1/366

(57) ABSTRACT

Disclosed is a solid-state plasma antenna that has an adjustable azimuth angle and declination angle and is applied even to a solid-state plasma antenna, which includes an electrode interconnection layer having a curve shape and an electronic path formed therein; a solid-state plasma cell array positioned at an inner side of the curve shape; a plasma activation controller electrically connected with the solid-state plasma cell array through the electrode interconnection layer and configured to activate at least one solid-state plasma cell in the solid plasma cell array based on an input signal; and an RF feed installed a predetermined distance from the inner side of the curve shape and configured to emit an RF signal to the solid-state plasma cell array.

### CLAIM FOR PRIORITY

This application claims priority to Korean Patent Application No. 2014-0008764 filed on Jan. 24, 2014 in the Korean Intellectual Property Office (KIPO), the entire contents of which are hereby incorporated by reference.

### BACKGROUND

1. Technical Field

Example embodiments of the present invention relate in general to a plasma antenna technique and more specifically to a solid-state plasma antenna that may electrically change a propagation direction of a beam while avoiding radio jamming

2. Related Art

For a solid-state plasma antenna, an electrical or optical stimulus is applied to a desired region of the semiconductor substrate that is a dielectric material as usual for a desired time, and the region is made conductive and used as an antenna.

By suitably using such state variability, adjustment of a direction of a beam and the like may be more easily implemented, which are generally implemented through a complex structure.

Conventionally, there is a technique for an antenna having an adjustable beam azimuth angle, and the antenna having the adjustable beam azimuth angle includes a cylindrical shielding structure having variable conductivity and an omnidirectional antenna positioned at a center of the cylinder.

In addition, the antenna having the adjustable beam azimuth angle may control conductivity of plasma to adjust a direction of an aperture, and thus the beam direction may be adjusted with respect to an azimuth angle of 360 degrees.

In general, since metal electrodes of a plasma tube using a gas are positioned at both ends thereof like in a fluorescent lamp, a tube in a non-conductive state does not disturb the propagation of the radio waves.

However, for the solid-state plasma antenna, the metal electrodes are distributed over a plasma surface to implement the above-described structure, thus disturbing the propagation of the radio waves.

In addition, conventionally, since the antenna having the adjustable beam azimuth angle has a cylindrical structure, a direction is variable with respect to only an azimuth angle.

### SUMMARY

Accordingly, example embodiments of the present invention are provided to substantially obviate one or more problems due to limitations and disadvantages of the related art.

Example embodiments of the present invention provide a solid-state plasma antenna that may adjust an azimuth angle and a declination angle of a beam and have no jamming element on a propagation path.

In some example embodiments, a solid-state plasma antenna includes an electrode interconnection layer having a curve shape and an electronic path formed therein, a solid-state plasma cell array positioned at an inner side of the curve shape, a plasma activation controller electrically connected with the solid-state plasma cell array through the electrode interconnection layer and configured to activate at least one solid-state plasma cell in the solid plasma cell array based on an input signal, and an RF feed installed a predetermined distance from the inner side of the curve shape and configured to emit an RF signal to the solid-state plasma cell array, in which the activated at least one solid-state plasma cell reflects the RF signal.

The plasma activation controller may activate at least one solid-state plasma cell in the solid-state plasma cell array based on an input signal including at least one of direction information and gain information associated with the reflection of the RF signal.

The electrode interconnection layer may be semi-cylindrical, hemispherical, or parabolic in shape.

The RF feed may have a dipole antenna structure when the electrode interconnection layer is semi-cylindrical in shape and have a dipole antenna or horn antenna structure when the electrode interconnection layer is hemispherical in shape.

In other example embodiments, a solid-state plasma antenna includes a plurality of electrode interconnection layers having curve shapes and electronic paths formed therein, a plurality of solid-state plasma cell arrays positioned at inner sides of the curve shapes, a plasma activation controller electrically connected with the plurality of solid-state plasma cell arrays through the plurality of electrode interconnection layers and configured to activate at least one solid-state plasma cell in the solid-state plasma cell arrays based on an input signal, and a plurality of RF feeds installed a predetermined distance from the inner sides of the curve shapes and configured to emit an RF signal to the plurality of solid-state plasma cell arrays.

The plurality of electrode interconnection layers may be positioned such that inner sides of the plurality of electrode interconnection layers are oriented in different directions.

The plurality of electrode interconnection layers may be positioned in three dimensions when the plurality of electrode interconnection layers are hemispherical in shape.

The activated at least one solid-state plasma cell may reflect the RF signal

The plasma activation controller may activate at least one solid-state plasma cell in the solid-state plasma cell array based on an input signal including at least one of direction information and gain information associated with the reflection of the RF signal.

The plurality of electrode interconnection layers may be semi-cylindrical, hemispherical, or parabolic in shape.

The RF feeds may have a dipole antenna structure when the plurality of electrode interconnection layers are semi-cylindrical in shape and have a dipole antenna or horn antenna structure when the plurality of electrode interconnection layers are hemispherical in shape.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view showing an antenna having an adjustable beam azimuth angle;

FIG. 2 is a conceptual view showing a method for implementing the antenna of FIG. 1;

FIG. 3 is a conceptual view showing a sectional view of a solid-state plasma antenna according to an embodiment of the present invention;

FIG. 4 is a conceptual view showing a sectional view of a solid-state plasma antenna according to another embodiment of the present invention; and

FIG. 5 is a conceptual view showing a sectional view of a solid-state plasma antenna according to still another embodiment of the present invention.

### DESCRIPTION OF EXAMPLE EMBODIMENTS

The present invention may be variously changed and may have various embodiments. Hereinafter, preferred embodiments of the present invention will be described in detail with reference to the accompanying drawings.

However, it should be understood that the present invention is not limited to these embodiments, and may include any and all modification, variations, equivalents, substitutions and the like within the spirit and scope thereof.

The terms ‘first,’ ‘second,’ and the like may be used to explain various other components, but these components are not limited to the terms. These terms are only used to distinguish one component from another. For example, a first component may be called a second component, and a second component may also be called a first component without departing from the scope of the present invention. The term ‘and/or’ means any one or a combination of a plurality of related and described items.

When it is mentioned that a certain component is “coupled with” or “connected with” another component, it will be understood that the certain component is directly “coupled with” or “connected with” to the other component or a further component may be located therebetween. In contrast, when it is mentioned that a certain component is “directly coupled with” or “directly connected with” another component, it will be understood that a further component is not located therebetween.

The terms used in the present specification are set forth to explain the embodiments of the present invention, and the scope of the present invention is not limited thereto. The singular number includes the plural number as long as they are not apparently different from each other in meaning. In the present specification, it will be understood that the terms “have,” “comprise,” “include,” and the like are used to designate features, figures, steps, operations, components, parts or combination thereof, and do not exclude them.

Unless otherwise defined, all terms (including technical and scientific terms) used herein have the same meaning as commonly understood by one of ordinary skill in the art to which this invention belongs. Terms, such as terms that are generally used and have been in dictionaries, should be construed as having meanings matched with contextual meanings in the art. In this description, unless defined clearly, terms are not ideally, excessively construed as formal meanings.

Hereinafter, preferred embodiments of the present invention will be described in detail with reference to the accompanying drawings. In describing the invention, in order to facilitate the entire understanding of the invention, like numbers refer to like components throughout the description of the figures and the repetitive description thereof will be omitted.

Components to be described below are components that are defined not by physical properties but by functional properties. Thus, each component may be defined by its function. Each component may be implemented as hardware and/or a program code and a processing unit for performing its function. The functions of two or more components may be implemented to be included in one component.

Accordingly, it should be noted that names of components in an embodiment to be described below are not given to physically classify the components but given to imply representative functions performed by the components, and the technical spirit of the present invention is not limited by the names of the components.

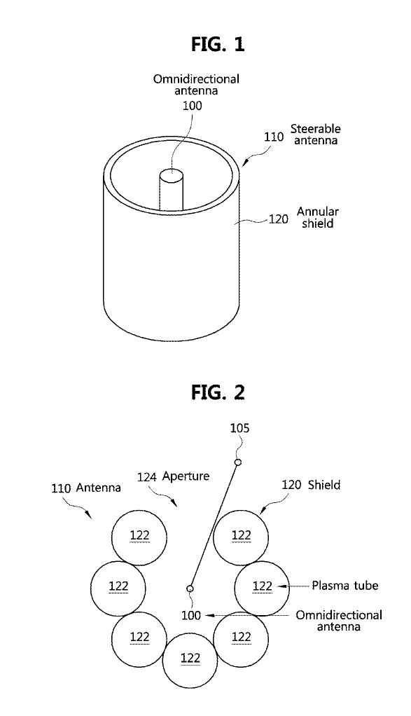

FIG. 1 is a conceptual view showing an antenna having an adjustable beam azimuth angle, and FIG. 2 is a conceptual view showing a method for implementing the antenna of FIG. 1.

Referring to FIGS. 1 and 2, an antenna having an adjustable beam azimuth angle includes one or more sealed plasma tubes 122 that contain a plasma gas.

Here, the plasma tubes 122 may have variable conductivity depending on an external electrode.

As shown in FIG. 2, when all the plasma tubes 122 are conductive while a plasma tube at an aperture 124 is removed or made to enter a non-conductive state, a radio wave formed by an omnidirectional antenna 100 is reflected by the plasma tubes 122 and forms a beam emitted to the outside through the aperture 124.

Since a direction of the aperture 124 may be adjusted by controlling conductivity of plasma, an antenna in which the beam azimuth angle may be adjusted from 0 to 360 degrees.

For the antenna described above, since, like in a fluorescent lamp, metal electrodes of a plasma tube using a gas are positioned at both ends thereof, a tube in a non-conductive state does not disturb the propagation of the radio waves.

However, for the solid-state plasma antenna, the metal electrodes are distributed over a plasma surface to implement the above-described structure, thus disturbing the propagation of the radio waves. In addition, since the antenna having the adjustable beam azimuth angle has a cylindrical structure, a direction is variable with respect to only an azimuth angle.

In order to solve the above-described problem, a solid-state plasma antenna according to an embodiment of the present invention will be described below with reference to drawings.

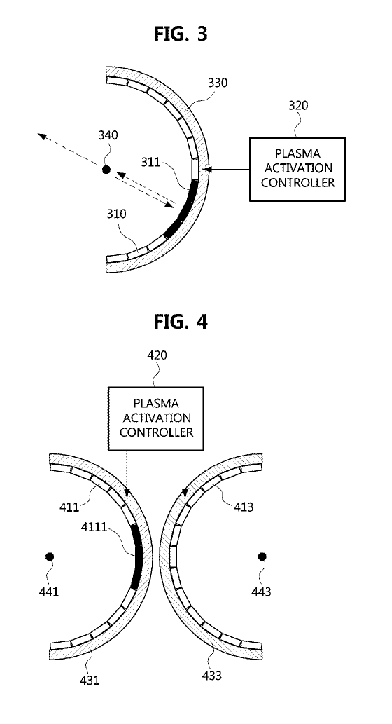

FIG. 3 is a conceptual view showing a cross section of a solid-state plasma antenna according to an embodiment of the present invention.

Referring to FIG. 3, a solid-state plasma antenna 300 according to an embodiment of the present invention may include a solid-state plasma cell array 310, a plasma activation controller 320, an electrode interconnection layer 330, and an RF feed 340.

The electrode interconnection layer 330 has a curve surface and an electric path formed therein to electrically connect the solid-state plasma cell array 310 and the plasma activation controller 320.

Here, the electrode interconnection layer 330 may be semi-cylindrical, hemispherical, parabolic, or the like in shape.

The solid-state plasma cell array 310 may be positioned at an inner side of the curve surface.

In addition, at least one solid-state plasma cell 311 that is activated by the plasma activation controller 320 in the solid-state plasma cell array 310 may serve as a reflective plate and reflect an RF signal that is emitted from the RF feed 340.

The plasma activation controller 320 may be electrically connected with the solid-state plasma cell array 310 through the electrode interconnection layer 330 and configured to activate the at least one solid-state plasma cell 311 in the solid-state plasma cell array 310 based on an input signal. In this case, the plasma activation controller 320 may control a reflective direction, a reflective gain, and the like of the RF signal by adjusting an active region.

Here, the input signal may include direction information, gain information, and the like associated with reflection of the RF signal. Thus, the plasma activation controller 320 may select a solid-state plasma cell to be activated in the solid-state plasma cell array 310 based on the input signal including the direction information, gain information, and the like associated with reflection of the RF signal and may activate the selected solid-state plasma cell.

The RF feed 340 may be installed a predetermined distance from the inner side of the curve surface and configured to emit an RF signal to the solid-state plasma cell array 310.

Here, when the electrode interconnection layer 330 is semi-cylindrical in shape, the RF feed 340 may have the structure of a dipole antenna (an antenna that serves as a dipole in which feeding is performed from a center of a conductive wire, which is a point in which an effective antenna length is one-half wavelength and thus linear electric potential distributions and polarities are always vertically or horizontally symmetrical about the center of the antenna). Alternatively, when the electrode interconnection layer 330 is hemispherical in shape, the RF feed 340 may have the structure of a dipole antenna or a horn antenna (a trumpet-shaped antenna formed by unfolding the edge of a waveguide, which is also referred to as an electronic horn).

In addition, an RF signal that is emitted by the RF feed 340 to the solid-state plasma cell array 310 may be reflected in a region of the activated solid-state plasma cell 311 in a direction opposite to the emission direction.

Advantageously, the solid-state plasma antenna according to an embodiment of the present invention uses a non-closed curve shape to have no jamming element on a propagation path. Thus a problem that an emission angle is limited may be solved. Furthermore, the solid-state plasma antenna may have an adjustable declination angle and azimuth angle and also may be applied even to the solid-state plasma antenna while the beam direction is adjustable.

FIG. 4 is a conceptual view showing a cross section of a solid-state plasma antenna according to another embodiment of the present invention.

Referring to FIG. 4, a solid-state plasma antenna 400 according to an embodiment of the present invention may include a first solid-state plasma cell array 411, a second solid-state plasma cell array 413, a plasma activation controller 420, a first electrode interconnection layer 431, a second electrode interconnection layer 433, a first RF feed 441, and a second RF feed 443.

The first electrode interconnection layer 431 has a curve shape and an electrical path formed therein to electrically connect the first solid-state plasma cell array 411 and the plasma activation controller 420.

The second electrode interconnection layer 433 has a curve shape and an electrical path formed therein to electrically connect the second solid-state plasma cell array 413 and the plasma activation controller 420.

In addition, the first electrode interconnection layer 431 and the second electrode interconnection layer 433 may be semi-cylindrical, hemispherical, parabolic, or the like in shape.

The first solid-state plasma cell array 411 and the second solid-state plasma cell array 413 may be positioned at inner sides of the curve shapes. In addition, the first solid-state plasma cell array 411 and the second solid-state plasma cell array 413 may have a structure in which outsides thereof are opposite each other, thus increasing an emission direction range of an RF signal. That is, the first solid-state plasma cell array 411 and the second solid-state plasma cell array 413 may have a structure in which insides thereof are oriented in opposite directions.

In addition, a specific solid-state plasma cell 4111 that is activated by the plasma activation controller 420 in the solid-state plasma cell array 411 may serve as a reflective plate to reflect an RF signal that is emitted from the first RF feed 441.

The plasma activation controller 420 may be electrically connected with the first solid-state plasma cell array 411 and the second solid-state plasma cell array 413 through the first electrode interconnection layer 431 and the second electrode interconnection layer 433 and configured to activate at least one solid-state plasma cell in the solid-state plasma cell array based on an input signal. In this case, the plasma activation controller 420 may control a reflective direction, a reflective gain, and the like of the RF signal by adjusting an active region.

Here, the input signal may include direction information, gain information, and the like associated with reflection of the RF signal. Thus, the plasma activation controller 420 may select a solid-state plasma cell to be activated in the first solid-state plasma cell array 411 and the second solid-state plasma cell array 413 based on the direction information, gain information, and the like associated with reflection of the RF signal and may activate the selected solid-state plasma cell.

The first RF feed 441 may be installed a predetermined distance from an inner side of a curve shape of the first electrode interconnection layer 431 and configured to emit an RF signal to the first solid-state plasma cell array 411.

Like the first RF feed 441, the second RF feed 443 may be installed a predetermined distance from an inner side of a curve shape of the second electrode interconnection layer 433 and configured to emit an RF signal to the second solid-state plasma cell array 413.

Here, when the first electrode interconnection layer 431 and the second electrode interconnection layer 433 are semi-cylindrical in shape, the first RF feed 441 and the second RF feed 443 may have a dipole antenna structure. Alternatively, when the first electrode interconnection layer 431 and the second electrode interconnection layer 433 are hemispherical in shape, the first RF feed 441 and the second RF feed 443 may have a dipole antenna structure or a horn antenna structure.

In addition, an RF signal that is emitted by the first RF feed 441 to the first solid-state plasma cell array 411 may be reflected in a region of the activated solid-state plasma cell 4111 in a direction opposite to the emission direction.

Advantageously, the solid-state plasma antenna according to another embodiment of the present invention may increase a range of an emission direction of an RF signal using two non-closed curve shapes, and also may be applied even to the solid-state plasma antenna while the beam direction is adjustable.

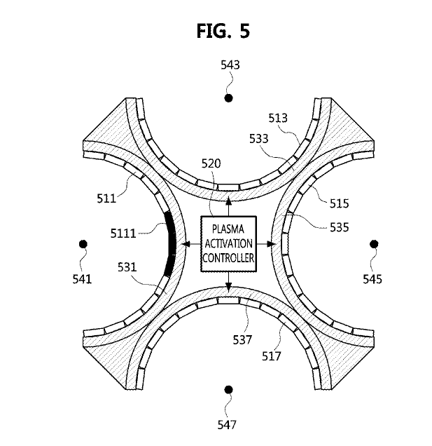

FIG. 5 is a conceptual view showing a cross section of a solid-state plasma antenna according to still another embodiment of the present invention.

Referring to FIG. 5, a solid-state plasma antenna 500 according to still another embodiment of the present invention may include a first solid-state plasma cell array 511, a second solid-state plasma cell array 513, a third solid-state plasma cell array 515, a fourth solid-state plasma cell array 517, a plasma activation controller 520, a first electrode interconnection layer 531, a second electrode interconnection layer 533, a third electrode interconnection layer 535, a fourth electrode interconnection layer 537, a first RF feed 541, a second RF feed 543, a third RF feed 545, and a fourth RF feed 547.

The first electrode interconnection layer 531 has a curve shape and an electrical path formed therein to electrically connect the first solid-state plasma cell array 511 and the plasma activation controller 520. As such, the second electrode interconnection layer 533 has a curve shape and an electrical path formed therein to electrically connect the second solid-state plasma cell array 513 and the plasma activation controller 520.

In addition, the third electrode interconnection layer 535 has a curve shape and an electrical path formed therein to electrically connect the third solid-state plasma cell array 515 and the plasma activation controller 520. Furthermore, the fourth electrode interconnection layer 537 has a curve shape and an electrical path formed therein to electrically connect the fourth solid-state plasma cell array 517 and the plasma activation controller 520.

The first solid-state plasma cell array 511 and the second solid-state plasma cell array 513, the third solid-state plasma cell array 515, and the fourth solid-state plasma cell array 517 may be positioned at inner sides of the curve shapes of the first electrode interconnection layer 531, the second electrode interconnection layer 533, the third electrode interconnection layer 535, and the fourth electrode interconnection layer 537.

In addition, the first electrode interconnection layer 531, the second electrode interconnection layer 533, the third electrode interconnection layer 535, and the fourth electrode interconnection layer 537 may have a structure in which outsides thereof are opposite each other and may be positioned to have the maximum emission direction range of the RF signal. That is, the first electrode interconnection layer 531, the second electrode interconnection layer 533, the third electrode interconnection layer 535, and the fourth electrode interconnection layer 537 may be positioned such that inner sides thereof are oriented in different directions.

In addition, a specific solid-state plasma cell 5111 that is activated by the plasma activation controller 520 in the first solid-state plasma cell array 511 may serve as a reflective plate to reflect an RF signal that is emitted from the first RF feed 541.

In addition, the first electrode interconnection layer 531, the second electrode interconnection layer 533, the third electrode interconnection layer 535, and the fourth electrode interconnection layer 537 may be semi-cylindrical, hemispherical, parabolic, or the like in shape.

The plasma activation controller 520 may be electrically connected to the first solid-state plasma cell array 511, the second solid-state plasma cell array 513, the third solid-state plasma cell array 515, and the fourth solid-state plasma cell array 517 through the first electrode interconnection layer 531, the second electrode interconnection layer 533, the third electrode interconnection layer 535, and the fourth electrode interconnection layer 537, respectively, and configured to activate a specific solid-state plasma cell 5111 in the first solid-state plasma cell array 511, the second solid-state plasma cell array 513, the third solid-state plasma cell array 515, and the fourth solid-state plasma cell array 517 based on an input signal.

Here, the plasma activation controller 520 may control a reflective direction, a reflective gain, and the like of the RF signal by adjusting an active region.

The first RF feed 541 may be spaced a predetermined distance from an inner side of the first electrode interconnection layer 531 and configured to apply an RF signal to the first solid-state plasma cell array 511.

Like the first RF feed 541, the second RF feed 543, the third RF feed 545, and the fourth RF feed 547 are spaced a predetermined distance from inner sides of the second electrode interconnection layer 533, the third electrode interconnection layer 535, and the fourth electrode interconnection layer 537 and configured to apply an RF signal to the second solid-state plasma cell array 513, the third solid-state plasma cell array 515, and the fourth solid-state plasma cell array 517, respectively.

Here, the first RF feed 541, the second RF feed 543, the third RF feed 545, and the fourth RF feed 547 may have a dipole antenna structure when the first electrode interconnection layer 531, the second electrode interconnection layer 533, the third electrode interconnection layer 535, and the fourth electrode interconnection layer 537 are semi-cylindrical in shape and have a dipole antenna or horn antenna structure when the first electrode interconnection layer 531, the second electrode interconnection layer 533, the third electrode interconnection layer 535, and the fourth electrode interconnection layer 537 are hemispherical in shape.

Furthermore, when the first electrode interconnection layer 531, the second electrode interconnection layer 533, the third electrode interconnection layer 535, and the fourth electrode interconnection layer 537 are hemispherical in shape, the first solid-state plasma cell array 511, the second solid-state plasma cell array 513, the third solid-state plasma cell array 515, and the fourth solid-state plasma cell array 517 may be positioned in three dimensions.

Advantageously, the above-described solid-state plasma antenna may increase a range of an emission direction of an RF signal using four non-closed curve shapes, and also may be applied even to the solid-state plasma antenna while the beam direction is adjustable.

The solid-state plasma antenna according to an embodiment of the present invention activates a specific solid-state plasma cell in a solid-state plasma cell array that is arranged in an electrode interconnection layer having a curve shape and an electronic path formed therein and then emits an RF signal to the solid plasma cell array such that the emitted RF signal may be reflected in an opposite direction from the activated specific solid-state plasma cell.

Accordingly, the solid-state plasma antenna has no jamming element on a propagation path, and thus an emission angle is not limited. Furthermore, the solid-state plasma antenna may have an adjustable declination angle and azimuth angle and also may be applied even to the solid-state plasma antenna while the beam direction is adjustable.

While the example embodiments of the present invention and their advantages have been described in detail, it should be understood that various changes, substitutions, and alterations may be made herein without departing from the scope of the invention.

What is claimed is:

1. A solid-state plasma antenna comprising:
an electrode interconnection layer having a curve shape and an electronic path formed therein;
a solid-state plasma cell array positioned at an inner side of the curve shape;
a plasma activation controller electrically connected with the solid-state plasma cell array through the electrode interconnection layer and configured to activate at least one solid-state plasma cell in the solid-state plasma cell array based on an input signal; and
an RF feed installed a predetermined distance from the inner side of the curve shape and configured to emit an RF signal to the solid-state plasma cell array,
wherein the activated at least one solid-state plasma cell reflects the RF

2. The solid-state plasma antenna of claim 1, wherein the plasma activation controller activates at least one solid-state plasma cell in the solid-state plasma cell array based on an input signal including at least one of direction information and gain information associated with the reflection of the RF signal.

3. The solid-state plasma antenna of claim 1, wherein the electrode interconnection layer is semi-cylindrical, hemispherical, or parabolic in shape.

4. The solid-state plasma antenna of claim 3, wherein the RF feed has a dipole antenna structure when the electrode interconnection layer is semi-cylindrical in shape and has a dipole antenna or horn antenna structure when the electrode interconnection layer is hemispherical in shape.

5. A solid-state plasma antenna comprising:
a plurality of electrode interconnection layers having curve shapes and electronic paths formed therein;
a plurality of solid-state plasma cell arrays positioned at inner sides of the curve shapes;
a plasma activation controller electrically connected with the plurality of solid-state plasma cell arrays through the plurality of electrode interconnection layers and configured to activate at least one solid-state plasma cell in the solid-state plasma cell arrays based on an input signal; and
a plurality of RF feeds installed a predetermined distance from the inner sides of the curve shapes and configured to emit an RF signal to the plurality of solid-state plasma cell arrays.

6. The solid-state plasma antenna of claim 5, wherein the plurality of electrode interconnection layers are positioned such that inner sides of the plurality of electrode interconnection layers are oriented in different directions.

7. The solid-state plasma antenna of claim 5, wherein the plurality of electrode interconnection layers are positioned in three dimensions when the plurality of electrode interconnection layers are hemispherical in shape.

8. The solid-state plasma antenna of claim 5, wherein the activated at least one solid-state plasma cell reflects the RF

9. The solid-state plasma antenna of claim 5, wherein the plasma activation controller activates at least one solid-state plasma cell in the solid-state plasma cell array based on an input signal including at least one of direction information and gain information associated with the reflection of the RF signal.

10. The solid-state plasma antenna of claim 5, wherein the plurality of electrode interconnection layers are semi-cylindrical, hemispherical, or parabolic in shape.

11. The solid-state plasma antenna of claim 10, wherein the RF feeds have a dipole antenna structure when the plurality of electrode interconnection layers are semi-cylindrical in shape and have a dipole antenna or horn antenna structure when the plurality of electrode interconnection layers are hemispherical in shape.
